(19) United States
(12) Patent Application Publication
(10) Pub. No.: US 2026/0276463 A1
(43) Pub. Date: Sep. 17, 2026

(54) TORQUE SENSOR, SENSING METHOD, AND STATOR WITH REDUCED CROSSTALK

(71) Applicant: SEMICONDUCTOR COMPONENTS INDUSTRIES, LLC, Scottsdale, AZ (US)

(72) Inventor: Jacques Jean BERTIN, Pocatello, ID (US)

(73) Assignee: SEMICONDUCTOR COMPONENTS INDUSTRIES, LLC, Scottsdale, AZ (US)

(21) Appl. No.: 19/394,183

(22) Filed: Nov. 19, 2025

Related U.S. Application Data
(60) Provisional application No. 63/770,177, filed on Mar. 11, 2025.

(51) Int. Cl. G01L 3/14; H02K 7/14; H02K 11/24

(52) U.S. Cl. CPC G01L 3/1492; H02K 11/24; H02K 7/145

(57) ABSTRACT

An illustrative stator includes: a first side proximate to a first rotor; and a second side proximate to a second rotor. A first receive coil includes a first main winding positioned on the first side to have a first dominant coupling to the first rotor and a second subordinate coupling to the second rotor, and a first offset winding positioned on the second side to have a second principal coupling to the second rotor to offset the second subordinate coupling. A second receive coil includes a second main winding positioned on the second side to have a second dominant coupling to the second rotor and a first subordinate coupling to the first rotor, and a second offset winding positioned on the first side to have a first principal coupling to the first rotor to offset the first subordinate coupling.

### CROSS REFERENCE TO RELATED APPLICATIONS

The present application claims benefit of provisional U.S. application 63/770,177, filed 2025-03-11 and titled “Crosstalk Reduction for Inductive Torque Sensor” by inventor Jacques Jean Bertin. The foregoing application is hereby incorporated herein by reference in its entirety.

### TECHNICAL FIELD

The present application relates to torque sensors and sensing methods, and more particularly, to those sensors and sensing methods employing a receive coil configuration that reduces rotor-receiver crosstalk.

### BACKGROUND

Torque is the rotational moment of a force. When applied via a shaft (e.g., an axle, a rod, a bolt, a relatively narrow component of a structure), a torque causes the shaft to twist and often to rotate about its axis. For most rigid materials, the amount of twist in the shaft is approximately proportional to the torque for values of torque below a given threshold where the material departs from the region of plastic deformation. (This threshold can be set quite high using steel or other metal alloys and/or using careful design of the shaft geometry.) This proportionality relationship enables sensors to measure the applied torque by detecting angular deviation between axially spaced portions of the shaft. The angular deviation is combined with a constant of proportionality to obtain the torque measurement, or if the desire is to ensure the torque does not exceed a given limit, a suitably scaled limit may be directly compared with the angular deviation measurement.

The angular deviation measurement can be determined by measuring an angular orientation of a first rotor on the shaft, measuring the angular orientation of a second rotor at a position axially spaced from the first rotor, and calculating the difference. Such orientation measurements can be obtained inductively. In co-owned U.S. Pat. No. 11,079,291 titled “Inductive Position Sensor”, which is hereby incorporated herein by reference in its entirety, inventor Jacques Jean Bertin discloses the use of a stator positioned between the first and second rotors with first and second receive coils to monitor the angular orientation of each rotor. However, if the stator-rotor distances vary due to, e.g., manufacturing tolerances that permit axial motion of the shaft, cross-coupling between the receive coils changes in a manner that may necessitate frequent recalibration and/or may cause a loss of measurement accuracy.

### SUMMARY

The foregoing issues are at least in part addressed by a torque sensor, sensing method, and stator design with reduced crosstalk. An illustrative stator includes: a first side configured to be proximate to a first rotor; and a second side configured to be proximate to a second rotor. The stator further includes a first receive coil and a second receive coil. In the first receive coil, a first main winding is positioned on the first side to have a first dominant coupling to the first rotor and a second subordinate coupling to the second rotor, and a first offset winding is positioned on the second side to have a second principal coupling to the second rotor to offset the second subordinate coupling. In the second receive coil, a second main winding is positioned on the second side to have a second dominant coupling to the second rotor and a first subordinate coupling to the first rotor, and a second offset winding is positioned on the first side to have a first principal coupling to the first rotor to offset the first subordinate coupling.

An illustrative sensor includes: a first rotor on a shaft, the first rotor having a first eddy coil; a second rotor spaced axially on the shaft from the first rotor, the second rotor having a second eddy coil; and a stator configured as given above and positioned between the first rotor and the second rotor.

An illustrative sensing method includes: driving an excitation coil on a stator with an alternating current that induces a first current flow in a first eddy coil of a first rotor on a shaft and a second current flow in a second eddy coil of a second rotor spaced axially on the shaft from the first rotor; determining a first signal amplitude in a first receive coil on the stator and a second signal amplitude in a second receive coil on the stator, the stator being configured as set forth above. The method may further include deriving a torque measurement based at least in part on the first signal amplitude and the second signal amplitude.

The foregoing examples can be employed individually or in conjunction and may include one or more of the following optional features in any suitable combination: 1. an excitation coil. 2. a controller configured to drive the excitation coil with an alternating current that induces a first current flow in the first eddy coil and a second current flow in the second eddy coil. 3. the controller is configured to determine a first signal amplitude in the first receive coil and a second signal amplitude in the second receive coil. 4. the controller is configured to derive a torque measurement based at least in part on the first signal amplitude and the second signal amplitude. 5. the excitation coil includes a first winding on the first side and a second winding on the second side. 6. the first offset winding includes a first clockwise component and a first counterclockwise component configured to minimize any direct coupling with the excitation coil. 7. the second eddy coil includes inward and outward deviations that couple with inward and outward deviations of the first offset winding. 8. the first main winding encloses the second offset winding, and the second main winding encloses the first offset winding. 9. the stator is formed from a printed circuit board with traces and vias forming the first main winding and second offset winding in at least two layers on the first side and traces and vias forming the second main winding and first offset winding in at least two layers on the second side. 10. the first receive coil is one of multiple angularly spaced receive coils each having a main winding on the first side and an offset winding on the second side, and the second receive coil is one of multiple angularly spaced receive coils each having a main winding on the second side and an offset winding on the first side.

### BRIEF DESCRIPTION OF THE DRAWINGS

FIG. 1 is a side view of an illustrative rotary device.

FIG. 2A is a side view of an illustrative torque sensor.

FIG. 2B is a plan view of an illustrative stator.

FIG. 2C is a plan view of an illustrative rotor.

FIG. 3A is a plan view of a first illustrative stator coil design.

FIG. 3B is a plan view of a second illustrative stator coil design.

FIG. 4 is a cutaway view of a torque sensor using the second illustrative stator coil design.

FIG. 5 is a cutaway view of a torque sensor using an illustrative stator coil design with reduced crosstalk.

FIG. 6A is a plan view of a third illustrative stator coil design.

FIG. 6B is a plan view of a fourth illustrative stator coil design.

FIG. 6C is a plan view of a fifth illustrative stator coil design.

FIG. 7 is a block diagram of an illustrative sensor controller.

### DETAILED DESCRIPTION

The drawings and following description do not limit the disclosure, but on the contrary, they provide the foundation for one of ordinary skill in the art to understand all modifications, equivalents, and alternatives falling within the scope of the claim language.

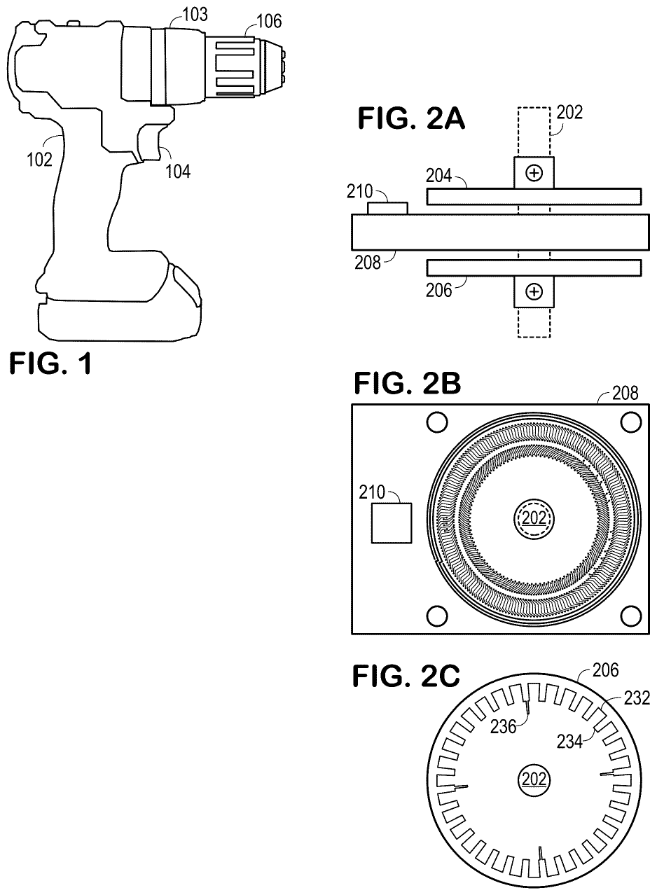

Torque sensors have wide applicability to mechanical systems in residential, commercial, and industrial contexts. As an example, FIG. 1 shows a power tool, namely a handheld portable electric drill 102, equipped with a torque limiter 103. When the user squeezes a trigger 104, the drill's internal motor rotates a chuck 106 along with any drill bit or driver bit that might be attached thereto. The torque limiter 103 disengages the chuck 106 from the internal motor when the applied torque exceeds the limit, which is typically adjustable by varying the orientation of the limiter 103. When properly adjusted, the limiter 103 is particularly useful for preventing the user from overdriving screws into the material being fastened. Conventional torque limiters 103 may employ a combination spring and friction mechanism having a friction disk or bearing that disengages the output shaft from the motor shaft when the torque limit is reached. The mechanism may exhibit severe vibration that ultimately leads to device failure. As an alternative, a contactless torque sensor may be used to generate a feedback signal enabling electrical control of the motor's output torque. This approach is expected to offer torque limiting with a vibration-free user experience and reduced risk of device failure.

An impact wrench is another example of a power tool that may benefit from the use of a contactless torque sensor. Impact wrenches employ a rotating “hammer” mechanism to repeatedly strike an “anvil” on the output shaft. Each strike yields a high torque impulse on the output shaft, but the user experiences a steady and reduced reaction force due to the tool's more gradual acceleration of the hammer mechanism. The dynamic nature of the tool's output torque may make it challenging to monitor, and the conventional approach may be to estimate the output torque based on the hammer's speed. A contactless torque sensor on the output shaft would offer improved accuracy to the measurement of peak torque, which could be displayed to enable the user to more reliably determine when a minimum required assembly torque has been reached.

Other suitable applications for contactless torque sensors include cobots, industrial robots, vehicle drive trains, steering mechanisms, screw-based lifting mechanisms, or indeed any mechanism employing a motor or other source of rotational motion. Control or safety monitoring systems for such mechanisms benefit from the improved accuracy and reliability offered by contactless torque sensors, particularly such sensors having no need or minimal need for sensor calibration.

FIG. 2A shows an illustrative torque sensor for a shaft 202. A first rotor 204 is secured to the shaft 202, rotating with the shaft as it rotates. A second rotor 206 is similarly secured to the shaft 202 with some axial separation provided between the two rotors. A stator 208 is positioned between the two rotors 204, 206, and may be kept stationary relative to the mechanism providing rotation of the shaft 202. It is contemplated that the stator 208 is a multilayer printed circuit board (PCB) assembly with a sensor controller chip 210 and an arrangement of coils as described further below. While a PCB-based implementation may be preferred due to reliability and cost considerations, other implementations may be suitable alternatives potentially offering other advantages. Such other implementations may be based on, e.g., high-density interconnect (HDI), ceramic substrate, semiconductor substrate technologies with suitably patterned conductive traces, or even using breadboard wiring and discrete components.

FIG. 2B is a plan view of the illustrative stator 208, showing an aperture for the shaft 202 and apertures for fasteners to secure the stator in place relative to the axis of the shaft. The sensor controller chip 210 is shown and may interact with the arrangement of coils as described further below. FIG. 2B shows only the top (layer 1) traces for the coil arrangement, which connect to traces of other layers that complete the arrangement. The coil arrangement centers on the axis of shaft 202 to align with the patterned coils of the two rotors 204, 206.

FIG. 2C is a plan view of the illustrative rotor 206. On the side nearest the stator 208, rotors 204, 206 each include a patterned eddy coil, which may be alternatively termed a rotor coil. The eddy coil forms a generally circular loop with periodic inward and outward deviations between an outer radius 232 and an inner radius 234. As will be seen below, the outer radius 232 and inner radius 234 may approximately match the corresponding dimensions of a receive coil on the stator 208. In some preferred implementations, the eddy coil further includes periodic inward and outward deviations between the inner radius 234 and an inmost radius 236, which may approximately match the corresponding dimensions of an offset coil on the stator 208. The inward and outward deviations provide an angle-dependent coupling strength between each eddy coils and the receive coils on the stator 208. It is contemplated that the rotors will be implemented using a single layer PCB using a trace to form each eddy coil, but other implementations are feasible. For example, each rotor may be implemented as a conductive disk with its outer rim having the desired eddy coil pattern.

The sensor controller applies an alternating current (AC) signal to a circular excitation coil on the stator. The excitation coil current creates a magnetic field that induces current flow in the eddy coils. In turn, the eddy coil current creates a magnetic field that creates an electromotive force (EMF) in the receive coils, which is detectable as a voltage signal between the terminals of each receive coil. The amplitude of the voltage signal is proportional to the coupling strength between the eddy coil and the corresponding receive coil. If the receive coil has a pattern of inward and outward deviations that at least approximately match those of the eddy coil, the coupling strength varies in a sinusoidal fashion as the eddy coil rotates relative to the receive coil, enabling the amplitude to be used as a measurement of the relative angle between the coils.

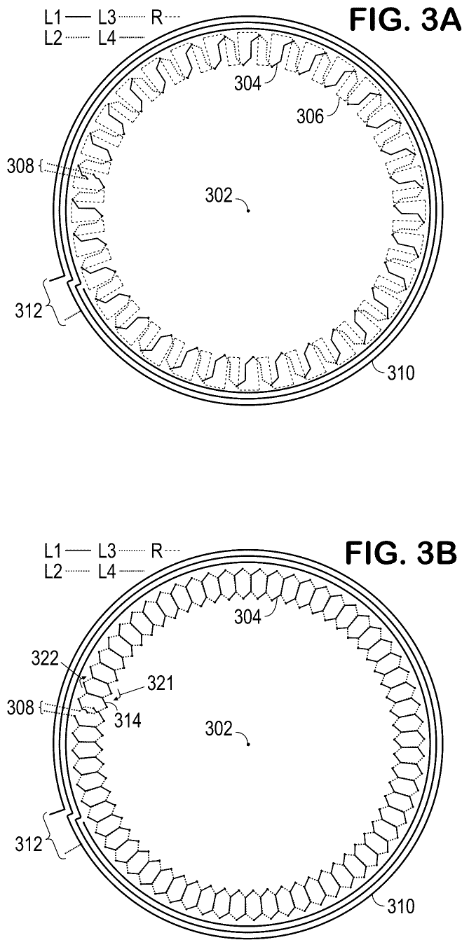

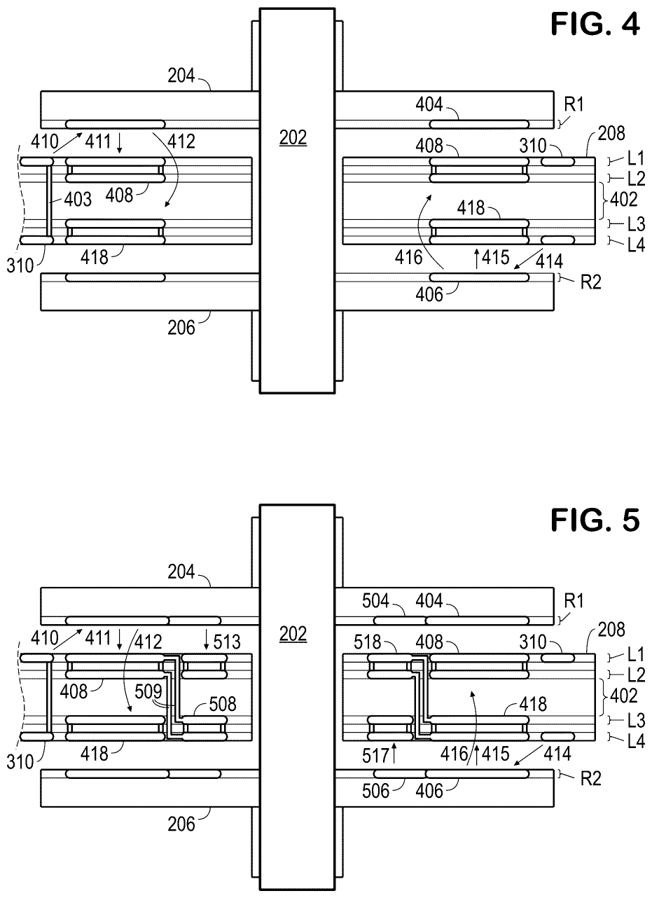

FIG. 3A shows a first illustrative stator coil arrangement, which is centered on an axis 302 of the shaft 202. The key shows line notation for traces in layer 1 (continuous), layer 2 (square dot), layer 3 (round dot), layer 4 (fine dash), and rotor (dash). (The relative layer positions can be seen in, e.g., the cutaway view of FIG. 4). Receive coil 304 is formed by traces in layers 1 and 2. Eddy coil 306 is shown here solely to show an illustrative alignment between the receive coil 304 and eddy coil. Each inward and outward deviation of the eddy coil 306 has a matching inward and outward deviation in the receive coil 304 with the coupling strength (and polarity) being dependent on the angular alignment between the coils. Alternating current flow in the eddy coil 306 causes an AC voltage signal between receive coil terminals 308. Current flow in the eddy coil 306 may be induced by alternating current flow in the excitation coil 310. (Excitation coil 310 may include circular traces in layer 1 connected in series with circular traces in layer 4. Other than the layer 4 terminal, the layer 4 traces are omitted for clarity.) The sensor controller drives the excitation coil 310 via excitation coil terminals 312.

A potential shortcoming of receive coil 304 is the existence of direct coupling with the excitation coil 310, such that the electromagnetic coupling from the excitation coil may be expected to overwhelm any signal generated by current flow in the eddy coil 306. FIG. 3B shows a second illustrative stator coil arrangement in which the receive coil has a counterclockwise component 304 (corresponding to the receive coil of FIG. 3A) augmented by a clockwise component 314. The use of traces in two layers enables the two components to be overlaid without short-circuits. To the extent that the excitation coil 310 directly induces a counterclockwise EMF 321 in receive coil component 304, it also induces an equal and opposite EMF 322 in receive coil component 314, thereby canceling the direct coupling between the excitation and receive coils. Notably, however, the inward deviations of the two components 304, 314 are aligned as are the outward deviations, preserving the coupling of those deviations with the corresponding inward and outward deviations of the eddy coil 306.

With a single receive coil, there is ambiguity in the angle measurement. A second and potentially a third receive coil may be overlaid on the first with respective angular shifts. The trace geometry permits such overlaid receive coils without necessitating additional conductor layers. Each receive coil has corresponding terminals from which the sensor controller may obtain voltage signals and derive relative amplitude measurements. Not only do the additional receive coils increase measurement resolution and remove ambiguity from the angle measurement, they may provide sufficient information to calculate and monitor certain coupling strength parameters including, e.g., cross-coupling strength.

FIG. 4 is a cutaway view of a torque sensor using the illustrative receive coil design of FIG. 3B. The vertical dimensions of FIGS. 4 and 5 are exaggerated for explanatory purposes. Excitation coil 310 includes traces in layer 1 (L1) and layer 4 (L4) connected by a via 403. Rotor 204 includes an eddy coil 404 on the surface proximate to the stator 208, i.e., layer R1. Rotor 206 includes an eddy coil 406 on the side proximate to the stator 208, i.e., layer R2. The stator 208 includes a substrate or core 402 supporting a first receive coil 408 formed by traces in layers L1, L2 on the side proximate to the first rotor 204. A second receive coil 418 is formed by traces in layers L3, L4 on the side proximate to the second rotor 206. As indicated by arrows 410, 414, alternating current flow in excitation coil 310 induces alternating current flow in eddy coils 404, 406. Eddy coil 404 electromagnetically couples to receive coil 408 as indicated by arrow 411 representing the dominant coupling of the first receive coil, and couples to receive coil 418 as indicated by arrow 412 representing the subordinate coupling of the second receive coil. Similarly, eddy coil 406 couples to receive coil 418 as indicated by arrow 415 representing the dominant coupling of the second receive coil, and to receive coil 408 as indicated by arrow 416 representing the subordinate coupling of the first receive coil.

The coupling strength falls off in inverse proportion to distance such that the subordinate coupling between a given receive coil and the more distant eddy coil (cross-coupling or “crosstalk”) may be much smaller than the dominant coupling to the nearer eddy coil (direct coupling). With an illustrative stator-rotor gap between about 0.5 mm and 1.0 mm and an illustrative stator PCB thickness between 1.5 mm and 3 mm, the cross-coupling strength can be estimated. Taking the mean values, the near-rotor distance would be 0.75 mm while the far-rotor distance would be 2.75 mm from the receive coil. In this situation, the crosstalk amplitude may be perhaps one or two percent of the direct signal, a significant amount when considering the small angular deviation that may be expected from torque applied to a steel shaft. Moreover, significant variation of the crosstalk amplitude may be expected if there is axial motion that, e.g., increases the distance to the near rotor while decreasing the distance to the far rotor.

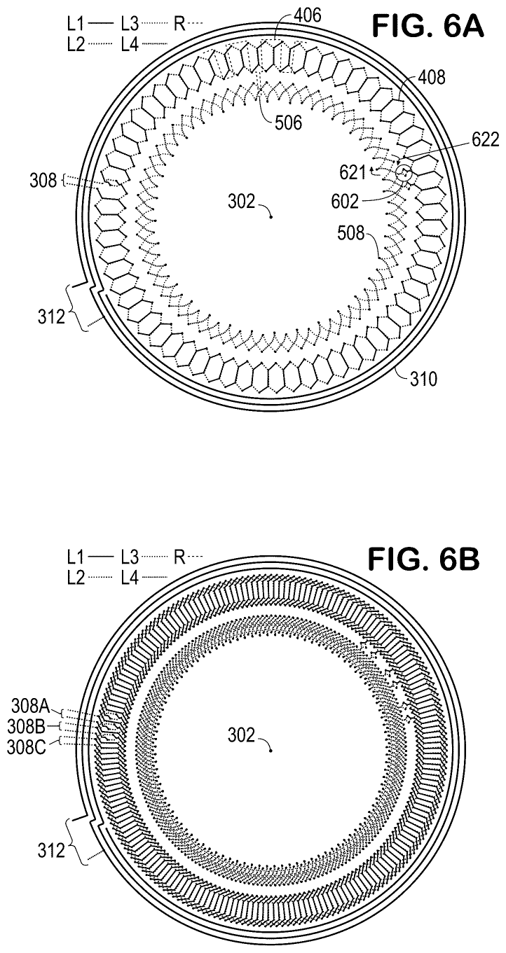

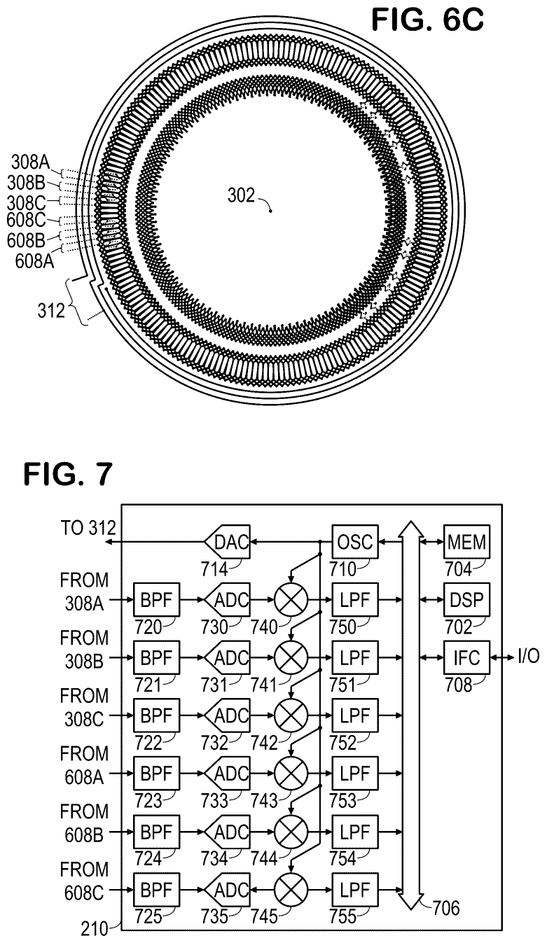

To reduce a receive coil's sensitivity to the far rotor, the coil configuration may be enhanced as shown in FIGS. 5-6C. The enhanced receive coil configuration includes a main winding 408 corresponding to clockwise and counterclockwise components 314, 304 of FIG. 3B and receive coil 408 of FIG. 4, and further includes an offset winding 508 having matched clockwise and counterclockwise components (FIG. 6A). While the main winding 408 is on the first side of the stator 208, i.e., the side proximate to the first rotor 204, the offset winding 508 is on the second side of the stator, i.e., the side proximate to the second rotor 206. Vias 509 may be used to place the offset winding 508 in electrical series with the main winding 408. The offset winding 508 couples to the eddy coil 406 as indicated by arrow 517 representing the principal coupling of the first offset winding.

In the disclosed examples, the inward and outward deviations of each winding is provided with 32 periods per revolution, as is the main component of each eddy coil. The strength of principal coupling 517 may be tailored with the use of additional inward and outward deviations 506 of the eddy coil 406 (FIG. 6A), enabling the offset coil 508 to offset the crosstalk indicated by subordinate coupling arrow 416. (Each eddy coil is shown with only four periods of additional inward and outward deviations due to the relatively small coupling desired with each offset winding.) Similarly, a second receive coil includes main winding 418 on the second side and offset winding 518 on the first side. The first eddy coil 404 includes additional inward and outward deviations 504 that couple to the offset winding as shown by arrow 513 representing the principal coupling to offset the crosstalk indicated by arrow 412 representing the subordinate coupling.

As shown in the plan view of FIG. 6A, the offset winding 508 includes a counterclockwise component 621 that encircles the axis 302 and is connected in series with the main winding's counterclockwise component 321 (FIG. 3B). A crossover 602 is provided at an intermediate point of the counterclockwise component 321, but it could equally well be made at either end. Another crossover similarly connects the clockwise component 622 of the offset winding 508 in series with the clockwise component 322 of the main winding 408. The clockwise and counterclockwise components are matched to minimize any direct coupling with the excitation coil, but the offset winding is placed proximate to the second rotor 206 to provide a principal coupling with the second eddy coil that offsets the main winding's subordinate coupling to the second eddy coil. Any change in stator-rotor distance is expected to affect the strengths of a given eddy coil's principal coupling and subordinate coupling in approximately equal measure, preserving the crosstalk cancelation. In tests of an initial prototype, the offset coils reduced the amplitude of the crosstalk by over an order of magnitude.

As previously mentioned, additional receive coils may be provided with angular shifts to remove measurement ambiguity and increase measurement resolution. FIG. 6B shows a stator coil arrangement having two additional enhanced receive coils overlaid on the enhanced receive coil of FIG. 6A. The overlaid receive coils each have an angular shift of ⅓ of the period. Three pairs of receive coil terminals are shown, labeled as 308A, 308B, 308C. In addition to the angular shifts, the receive coils vary in terms of the crossover positioning, which does not impact their operation but avoids requiring additional wiring layers to prevent short circuits.

FIG. 6B shows the three coils with dominant coupling to the first eddy coil to measure the relative angle of the first rotor. When the three coils with dominant coupling to the second eddy coil are included to measure the relative angle of the second rotor, the plan view may be as shown in FIG. 6C, with a total of six pairs of receive coil terminals 308A-308C and 608A-608C. Each offset winding is enclosed within the main winding of the other receive coil.

FIG. 7 is a block diagram of an illustrative sensor controller chip 210 having a digital signal processor 702 configured to execute firmware instructions retrievable from an embedded or external memory 704 via a bus 706. The bus 706 may further couple the processor 702 to an interface 708 that supports a given input/output protocol for receiving commands from a host processor and for communicating measurement results. The firmware may cause the processor 702 to configure a digital oscillator 710 to generate a clock signal having a desired frequency. (The torque sensor can operate across a wide frequency range, but a carrier frequency in the range between 1 MHz to 10 MHz may offer the best balance of various performance considerations.) A digital to analog converter 714 may be used to convert the digital clock signal into an analog drive signal for the excitation coil. The drive signal may be provided as a single-ended signal, but a differential signal may be preferred to minimize electromagnetic emissions.

As previously mentioned, the excitation coil induces current flow in the eddy coils, which in turn produces voltage signals at the receive coil terminals. A set of low pass or bandpass filters 720-725 may screen unwanted noise from the receive signals. A set of analog to digital converters 730-735 digitizes the filtered receive signals. A set of mixers 740-735 together with a set of corresponding low pass filters 750-755 may convert the digital receive signals to baseband measurements of receive signal amplitudes, which can be retrieved by the digital signal processor and converted into rotor angle measurements and to torque measurements. The number of parallel paths in the sensor controller can optionally be reduced by multiplexing a smaller number of paths. Incorporated reference U.S. Pat. No. 11,079,291 discloses the mathematics for one approach to converting amplitudes to angles.

If no torque is applied to the shaft 202, the difference between the two angles is constant and set by the relative angles between the two rotors. Even as the shaft rotates freely, the measured angle difference is constant, independent of the absolute angle of the shaft or its rotational speed. If a torque is applied across the shaft, the angle difference between the two rotors increases proportionally to the torque. With knowledge of the shaft's torsional stiffness and the axial distance between the two rotors, the difference in the rotor angles can be used to measure the applied torque.

As noted above, the received signal amplitude decreases as the air gap increases, and when caused by axial motion of the shaft, this amplitude decrease coincides with an increase in crosstalk amplitude. The enhanced receive coil design decreases sensitivity to the crosstalk to reduce this effect and enable more accurate torque measurement. The offset windings may be printed on the same PCB as the main windings without requiring additional layers. The eddy coils may be slightly modified to provide the desired amount of coupling with the offset windings. As the cross-coupling to the main windings is relatively small, the eddy coils may need only a small number of additional inward and outward deviations to provide the desired coupling to the offset coils to achieve proper matching to the crosstalk and its air gap dependency. The coupling polarity and amplitude is such that this additional coupling balances the crosstalk. The crosstalk compensation is such that it tracks the rotor air gap. If a rotor is closer to the stator, the crosstalk increases but also the compensation.

It is contemplated that the control logic will be implemented as a firmware-configured digital signal processor, but suitable alternatives include an application specific integrated circuit (ASIC) state machine.

While the dependent claims below are written to refer back to a single claim as a matter of claim drafting prescriptions in certain countries, it is observed that any combination of a dependent claim with any of its preceding claims is foreseen by the present inventors and is deemed included in the full disclosure of the present application. Furthermore, it is to be understood that the dependent claims depending from a given base claim will also be applicable to the other independent claims but have merely been omitted for the sake of limiting the overall number of claims and any claim fees that may be due as a result thereof.

What is claimed is:

1. A sensor that comprises:
a first rotor on a shaft, the first rotor having a first eddy coil;
a second rotor spaced axially on the shaft from the first rotor, the second rotor having a second eddy coil; and
a stator between the first rotor and the second rotor, the stator having:
a first side proximate to the first rotor,
a second side proximate to the second rotor,
a first receive coil including:
a first main winding on the first side having a first dominant coupling to the first eddy coil and a second subordinate coupling to the second eddy coil, and
a first offset winding on the second side having a second principal coupling to the second eddy coil to offset the second subordinate coupling; and
a second receive coil including:
a second main winding on the second side having a second dominant coupling to the second eddy coil and a first subordinate coupling to the first eddy coil, and
a second offset winding on the first side having a first principal coupling to the first eddy coil to offset the first subordinate coupling.

2. The sensor of claim 1, further comprising:
an excitation coil; and
a controller configured to drive the excitation coil with an alternating current that induces a first current flow in the first eddy coil and a second current flow in the second eddy coil, the controller further configured to determine a first signal amplitude in the first receive coil and a second signal amplitude in the second receive coil.

3. The sensor of claim 2, wherein the controller is configured to derive a torque measurement based at least in part on the first signal amplitude and the second signal amplitude.

4. The sensor of claim 2, wherein the excitation coil includes a first winding on the first side and a second winding on the second side.

5. The sensor of claim 2, wherein the first main winding and first offset winding collectively include a first clockwise component and a first counterclockwise component configured to minimize any direct coupling with the excitation coil.

6. The sensor of claim 2, wherein the second eddy coil includes inward and outward deviations that couple with inward and outward deviations of the first offset winding.

7. The sensor of claim 2, wherein the first main winding encloses the second offset winding, and wherein the second main winding encloses the first offset winding.

8. The sensor of claim 1, wherein the stator comprises a printed circuit board including traces and vias forming the first main winding and second offset winding in at least two layers on the first side and traces and vias forming the second main winding and first offset winding in at least two layers on the second side.

9. The sensor of claim 1, wherein the first receive coil is one of multiple angularly shifted receive coils each having a main winding on the first side and an offset winding on the second side, and wherein the second receive coil is one of multiple angularly shifted receive coils each having a main winding on the second side and an offset winding on the first side.

10. A stator that comprises:
a first side configured to be proximate to a first rotor;
a second side configured to be proximate to a second rotor;
a first receive coil including:
a first main winding on the first side to have a first dominant coupling to the first rotor and a second subordinate coupling to the second rotor; and
a first offset winding on the second side to have a second principal coupling to the second rotor to offset the second subordinate coupling; and
a second receive coil including:
a second main winding on the second side to have a second dominant coupling to the second rotor and a first subordinate coupling to the first rotor; and
a second offset winding on the first side to have a first principal coupling to the first rotor to offset the first subordinate coupling.

11. The stator of claim 10, further comprising:
an excitation coil; and
a controller configured to drive the excitation coil with an alternating current that induces a first current flow on the first rotor and a second current flow on the second rotor, the controller further configured to determine a first signal amplitude in the first receive coil and a second signal amplitude in the second receive coil.

12. The stator of claim 11, wherein the controller is configured to derive a torque measurement based at least in part on the first signal amplitude and the second signal amplitude.

13. The stator of claim 11, wherein the excitation coil includes a first winding on the first side and a second winding on the second side.

14. The stator of claim 11, wherein the first offset winding includes a first clockwise component and a first counterclockwise component configured to minimize any direct coupling with the excitation coil.

15. The stator of claim 10, wherein the first main winding encloses the second offset winding, and wherein the second main winding encloses the first offset winding.

16. The stator of claim 10, wherein the stator comprises a printed circuit board including traces and vias forming the first main winding and second offset winding in at least two layers on the first side and traces and vias forming the second main winding and first offset winding in at least two layers on the second side.

17. The stator of claim 10, wherein the first receive coil is one of multiple angularly shifted receive coils each having a main winding on the first side and an offset winding on the second side, and wherein the second receive coil is one of multiple angularly shifted receive coils each having a main winding on the second side and an offset winding on the first side.

18. A sensing method that comprises:
driving an excitation coil on a stator with an alternating current that induces a first current flow in a first eddy coil of a first rotor on a shaft and a second current flow in a second eddy coil of a second rotor spaced axially on the shaft from the first rotor;
determining a first signal amplitude in a first receive coil on the stator and a second signal amplitude in a second receive coil on the stator, the stator having:
a first side proximate to the first rotor,
a second side proximate to the second rotor,
the first receive coil with:
a first main winding on the first side having a first dominant coupling to the first eddy coil and a second subordinate coupling to the second eddy coil, and
a first offset winding on the second side having a second principal coupling to the second eddy coil to offset the second subordinate coupling; and
the second receive coil with:
a second main winding on the second side having a second dominant coupling to the second eddy coil and a first subordinate coupling to the first eddy coil, and
a second offset winding on the first side having a first principal coupling to the first eddy coil to offset the first subordinate coupling.

19. The sensing method of claim 18, further comprising:
deriving a torque measurement based at least in part on the first signal amplitude and the second signal amplitude.

20. The sensing method of claim 18, wherein the first main winding encloses the second offset winding, and wherein the second main winding encloses the first offset winding.
